(19) United States
(12) Patent Application Publication
(10) Pub. No.: US 2021/0209295 A1
(43) Pub. Date: Jul. 8, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Masato ANDO, Kanagawa (JP); Hirokazu MUKAI, Kanagawa (JP); Tomoyuki ITO, Kanagawa (JP); Yoshiyuki TAKASHIMA, Kanagawa (JP)

(73) Assignee: FUJI XEROX CO., LTD., Tokyo (JP)

(21) Appl. No.: 16/945,929

(22) Filed: Aug. 2, 2020

(30) Foreign Application Priority Data
Jan. 7, 2020 (JP) 2020-000869

(51) Int. Cl. G06F 40/177; G06F 16/28

(52) U.S. Cl. CPC G06F 40/177; G06F 16/288

(57) ABSTRACT

An information processing apparatus includes a processor. The processer is configured to receive relation information generated by systematically connecting plural items representing events in accordance with relations of the items, extract, from the relation information, information for identifying the items and information for identifying the relation for each of the items, arrange the items based on the extracted information for identifying the relation for each of the items to generate a table in which attribute information of the items is allowed to be input, and output the generated table.

### CROSS-REFERENCE TO RELATED APPLICATIONS

This application is based on and claims priority under 35 USC 119 from Japanese Patent Application No. 2020-000869 filed Jan. 7, 2020.

### BACKGROUND

### (i) Technical Field

The present disclosure relates to an information processing apparatus and a non-transitory computer readable medium.

### (ii) Related Art

Japanese Unexamined Patent Application Publication No. 2016-081185 describes a disclosure of an information processing apparatus. The information processing apparatus includes an acceptance unit, a deployment unit, and an output unit. A relation diagram is created by systematically connecting plural function items in accordance with dependence relations of the function items, each of the plural function items representing a function related to quality function deployment. Among the plural function items, a function item representing a function belonging to any of plural processes in the quality function deployment is provided with attribute information for identifying the process to which the function item belongs. Upon the relation diagram being input, the acceptance unit extracts, from the relation diagram, information for identifying the function item, the attribute information provided for the function item, and dependence information for identifying the dependence relations between the function items and accepts them as raw information. The deployment unit classifies the function items according to the process on the basis of the attribute information in the raw information, creates deployment information used for deploying the classified function items for each process, and deploys, on the basis of the deployment information, the raw information into a deployment chart in which the function items are deployed and in which the processes are axes. The output unit outputs the deployment chart deployed by the deployment unit.

### SUMMARY

In a typical relation diagram representing logical relations between events, many events are linked in a chained manner and in a crossed manner. In order to grasp all downstream events related to upstream events, it is necessary to track relation lines in the relation diagram one by one.

Aspects of non-limiting embodiments of the present disclosure relate to an information processing apparatus and a non-transitory computer readable medium by which, even if many items representing events are related in a chained manner and in a crossed manner, relations between the events may be grasped more easily than using a relation diagram.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor. The processer is configured to receive relation information generated by systematically connecting plural items representing events in accordance with relations of the items, extract, from the relation information, information for identifying the items and information for identifying the relation for each of the items, arrange the items based on the extracted information for identifying the relation for each of the items to generate a table in which attribute information of the items is allowed to be input, and output the generated table.

### BRIEF DESCRIPTION OF THE DRAWINGS

An exemplary embodiment of the present disclosure will be described in detail based on the following figures, wherein:

FIG. 1 schematically illustrates a configuration of an information processing system according to the exemplary embodiment;

FIG. 2 is a block diagram illustrating a hardware configuration of a server;

FIG. 3 is a block diagram illustrating an example of a functional configuration of the server;

FIG. 4 illustrates a data structure example of a relation diagram information table;

FIG. 5 illustrates a data structure example of an item information table;

FIG. 6 illustrates a data structure example of a relation line information table;

FIG. 7 is a flowchart illustrating a flow of a relation table generation process performed by the server;

FIG. 8 illustrates an example of a relation diagram from which a relation table is to be generated;

FIG. 9 illustrates an example of a relation table generated from the relation diagram illustrated in FIG. 8;

FIG. 10 illustrates a deployment chart created from the relation diagram illustrated in FIG. 8; and

FIG. 11 illustrates an example of the relation table generated by a CPU.

### DETAILED DESCRIPTION

Hereinafter, an example of an exemplary embodiment of the present disclosure will be described with reference to the attached drawings. Note that identical or equivalent components and sections are denoted by the same reference numerals in the drawings. In addition, the dimensional ratios in the drawings may be different from the actual ratios by being exaggerated for convenience of description.

First, the background to the exemplary embodiment of the present disclosure that the inventors have arrived at will be described.

Typically, in a system using complex physical phenomena, many events are linked to each other in a chained manner. For example, an effect, such as a final quality of a product, may be caused by plural events, which are caused by plural other events, and the plural other events are caused by plural still other events. In such a complex system, a large number of qualities need to be assured, and relations between designs and qualities are extremely complex. Accordingly, it is difficult to find a design item that assures a desired quality, and a change in design value for assuring a certain quality may tend to adversely affect the other qualities.

To visualize and organize such complex relations, relation information is used. The relation information refers to information in which items and relations between the items are defined. An example of the relation information is a relation diagram representing relations by connecting plural items to each other via relation lines. Each of the items represents an event and has attributes such as an item name and characteristics. An example of the relation diagram is a logic tree. The relation diagram is suitably used to indicate items representing events serving as effects and items representing events serving as causes of the effects in detail without any missing or overlapping item.

Another example of the relation information is a quality function deployment chart representing relations between events listed on plural axes that intersect with each other, by using symbols or numeric values arranged in a matrix. The quality function deployment chart represents relations in a matrix in which some events are extracted from among many events and arranged on axes. Thus, relations between many events serving as effects and many events serving as causes may be represented simply.

However, if a relation diagram includes too many items representing target events, the diagram becomes excessively complex and large. In addition, the quality function deployment chart is incapable of representing detailed relations including items representing events that are not arranged on axes, and as a result, the items tend to be missing.

In a typical, widely used quality function deployment chart, events serving as causes and events serving as effects are arranged on two axes, the horizontal axis and the vertical axis, and is incapable of including information about the reasons for the indicated relations. However, it is useful to use a multi-axis quality function deployment chart representing overall relations in which three or more axes are arranged to intersect with one another and some causes are extracted and illustrated from among the causes constituting the relations.

From the above description, by using both a relation diagram and a multi-axis quality function deployment chart, it is possible to extract and illustrate relations in detail without any missing or overlapping item, while simply displaying the relations between many events serving as causes and many events serving as effects. However, it is complicated to convert a relation diagram into a multi-axis quality function deployment chart or to convert a multi-axis quality function deployment chart into a relation diagram, and a system that supports the conversion is necessary.

In a case where a two-axis quality function deployment chart is to be displayed by depicting a relation diagram having hierarchical relations between items representing events and selecting a level therefrom, in order to create a hierarchical relation diagram, the relations need to be originally organized in a hierarchical manner. Unless the relations are originally organized in a hierarchical manner, it is difficult to depict hierarchical relations in detail without any missing or overlapping item, which is the purpose of the disclosure. Even if events are classified as hierarchy, display of all events in a selected level in the quality function deployment chart increases the information amount to be displayed, which hinders the purpose to extract and display some events serving as causes.

The disclosure disclosed in Japanese Unexamined Patent Application Publication No. 2016-081185 proposes deployment of a quality function deployment chart after selecting an event corresponding to each axis of the quality function deployment chart on a created relation diagram. In this technique, however, information of the relation diagram is condensed to create a quality function deployment chart. This decreases information of the quality function deployment chart much less than information of the relation diagram. Thus, although it is possible to deploy the quality function deployment chart from the relation diagram, it is difficult in turn to reflect any changes of the quality function deployment chart in the relation diagram.

As described above, the relation diagram and the quality function deployment chart have different roles to visualize the same relations between events. Accordingly, it is desired, not only to use either one or to convert either one into the other in one way, but also to create and view both back and forth while keeping all information of complex event relations.

Accordingly, this exemplary embodiment will describe a technique by which, on the basis of relation information for creating a relation diagram and a quality function deployment chart, information for making it easy to grasp relations between events may be generated and output.

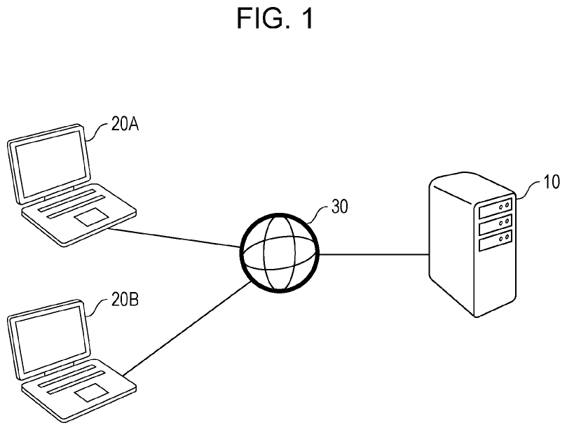

FIG. 1 schematically illustrates a configuration of an information processing system according to the exemplary embodiment. FIG. 1 illustrates a server 10 as an information processing apparatus and user terminals 20A and 20B.

The server 10 is an apparatus that generates and outputs, on the basis of relation information for creating a relation diagram and a quality function deployment chart, information for making it easy to grasp relations between events. Specifically, the server 10 generates and outputs, on the basis of relation information, a table for making it easy to grasp relations between events. In the following description, the table generated by the server 10 will be referred to as a relation table.

The relation information is generated by systematically connecting plural items in accordance with predetermined relations between the items. Each of the items may be a function item indicating a function. The relations between the items may include a dependence relation or a hierarchical relation. Each function item may have attribute information. The attribute information may be a numeric value or a character. The relation information may be a relation diagram representing dependence relations by linking function items via lines. Alternatively, the relation information may be a multi-axis deployment chart, in which processes are arranged on axes, representing dependence relations by deploying function items belonging to any of plural processes.

The exemplary embodiment is applicable to a relation table generation process for performing processing to obtain a relation table from various charts, such as a deployment chart and a two-element chart in quality function deployment. For example, in designing a product or a service, a design quality that satisfies customers is set, and in order to embody the set design quality, quality function deployment is applied to checking of dependence relations with the function items or components. In quality function deployment, it is necessary to check actual dependence relations properly, and thus, in quality function deployment, many function items such as a design quality are set accurately without any missing item (without any omission). In addition, in quality function deployment, one or more processes among a series of related processes are arranged on axes, function items of the processes are displayed systematically in a hierarchical manner, and thereby correspondence relations between the function items are clarified.

The exemplary embodiment is applied to generation of a relation table from a two-element chart representing correspondence relations (dependence relations) between function items in two processes by combining correspondence relations between two related processes (e.g., correspondence relations in a deployment chart in which processes are arranged on axes) for quality function deployment of various cases. The two-element chart in quality function deployment may be any of various charts, such as a required quality deployment chart, a quality element (characteristics) deployment chart, a planned quality setting chart, a design quality setting chart, a function deployment chart, a mechanism deployment chart, a unit/component deployment chart, a method deployment chart, a new idea deployment chart, and a cost deployment chart. The two-element chart may further be any of various charts, such as a cost plan setting chart, a material deployment chart, a fault tree (FT) deployment chart, a reliability plan setting chart, a measurement equipment deployment chart, a measurement method deployment chart, a business function deployment chart, a technique deployment chart, a quality assurance (QA) chart, a quality control (QC) step chart, and an assured item deployment chart. The exemplary embodiment is applied to generation of a relation table from any of these charts. Without limitation to the above, the exemplary embodiment may be applied to generation of a relation table from a two-element chart representing correspondence relations between desired processes.

Furthermore, the quality function deployment according to the exemplary embodiment is applied to generation of a relation table from a diagram for quality function deployment representing correspondence relations between function items in each process by combining correspondence relations between, not only two processes, but also three or more (e.g., three or four) processes. Note that in the following description, a diagram for quality function deployment representing correspondence relations between plural processes will be referred to as “multi-element chart”. That is, in the following description, a multi-element chart representing correspondence relations between two processes is referred to as a two-element chart, a multi-element chart representing correspondence relations between three processes is referred to as a three-element chart, and a multi-element chart representing correspondence relations between four processes is referred to as a four-element chart. In addition, in the exemplary embodiment, a process refers to a series of actions that relate to or act on each other for a target case, such as quality-performance-structure-material. Between related processes, an output of a process serves as an input for another (see, for example, JIS Q 9000).

Each of the user terminals 20A and 20B is an apparatus that is connected to the server 10 via a network 30, such as the Internet or an intranet, to edit relation information or to issue an instruction for generating a relation table from the relation information. The user terminals 20A and 20B are used by different users. Although FIG. 1 illustrates two user terminals, the number of user terminals is not limited to a particular number in the information processing system. Each user terminal may be any apparatus having a function to be connected to the network 30, such as a personal computer, a smartphone, or a tablet terminal. In the following description, unless it is necessary to distinguish the user terminals 20A and 20B from each other, the user terminals 20A and 20B will be simply referred to as a user terminal 20.

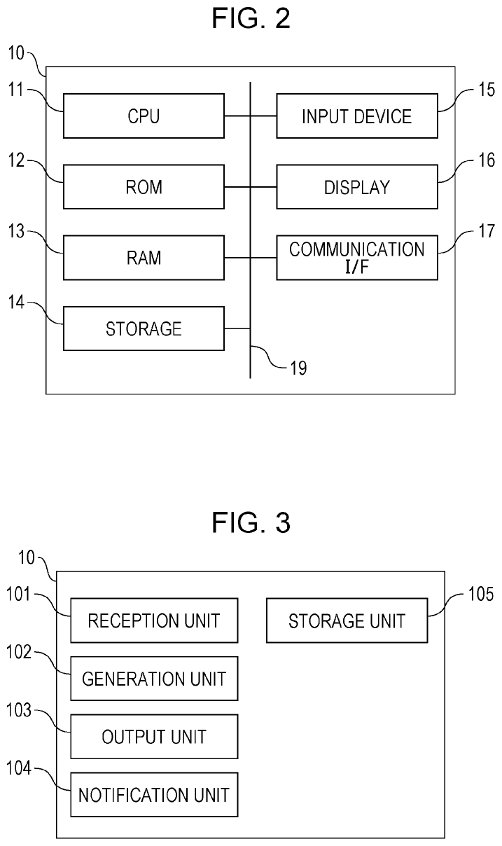

FIG. 2 is a block diagram illustrating a hardware configuration of the server 10.

As illustrated in FIG. 2, the server 10 includes a central processing unit (CPU) 11, a read only memory (ROM) 12, a random access memory (RAM) 13, a storage 14, an input device 15, a display 16, and a communication interface (I/F) 17. The components are connected to each other via a bus 19 to be able to communicate with each other.

The CPU 11 executes various programs or controls each unit. That is, the CPU 11 reads a program from the ROM 12 or the storage 14 and executes the program by using the RAM 13 as a work area. In accordance with the program recorded on the ROM 12 or the storage 14, the CPU 11 controls the above components and performs various arithmetic processes. In the exemplary embodiment, the ROM 12 or the storage 14 stores a relation table generation program for generating a relation table.

The ROM 12 stores various programs and various kinds of data. The RAM 13 temporarily stores a program or data as a work area. The storage 14 is constituted by a storage device such as a hard disk drive (HDD), a solid state drive (SSD), or a flash memory, and stores various programs including an operating system and various kinds of data.

The input device 15 includes a pointing device, such as a mouse, and a keyboard and is used by a user to input various kinds of information.

The display 16 is, for example, a liquid crystal display and displays various kinds of information. The display 16 may also function as the input device 15 by employing a touch panel.

The communication interface 17 is an interface for communicating with other equipment such as a user terminal 20, and for example, a standard such as Ethernet (registered trademark), Fiber Distributed Data Interface (FDDI), or Wi-Fi (registered trademark) is used.

When executing the above relation table generation program, the server 10 implements various functions by using the above hardware resources. The functional configuration implemented by the server 10 will be described.

Next, the functional configuration of the server 10 will be described.

FIG. 3 is a block diagram illustrating an example of the functional configuration of the server 10.

As illustrated in FIG. 3, as the functional configuration, the server 10 includes a reception unit 101, a generation unit 102, an output unit 103, a notification unit 104, and a storage unit 105. Each function is implemented by the CPU 11 reading and executing the relation table generation program stored in the ROM 12 or the storage 14.

The reception unit 101 receives input of relation information from which a relation table is to be generated. The relation information from which a relation table is to be generated is stored in, for example, the storage unit 105. In accordance with a generation instruction for generating a relation table from the relation information received from a user terminal 20, the reception unit 101 acquires the relation information from the storage unit 105.

The generation unit 102 generates a relation table from the relation information received by the reception unit 101. The method for generating a relation table from the relation information will be described later in detail.

The output unit 103 outputs the relation table generated by the generation unit 102. The relation table is output to the user terminal 20 that has transmitted the instruction for generating the relation table. In addition, the output unit 103 stores the relation table generated by the generation unit 102 in the storage unit 105.

The notification unit 104 notifies the user terminal 20 that is displaying the relation table of information about the relation table generated by the generation unit 102. For example, if identical items are present when editing attribute information of an item, the notification unit 104 notifies the user terminal 20 displaying the relation table that identical items are present. In addition, for example, if identical items are present when editing attribute information of an item, the notification unit 104 displays a notification of information about the number of identical items. Examples of the information about the relation table as a notification displayed by the notification unit 104 will be described later in detail.

The storage unit 105 stores various kinds of information about operations of the server 10. In the exemplary embodiment, the storage unit 105 stores information about relation information. For example, if the relation information is a relation diagram, the storage unit 105 stores a relation diagram information table, an item information table, and a relation line information table. Herein, examples of the information about relation information stored in the storage unit 105 will be described.

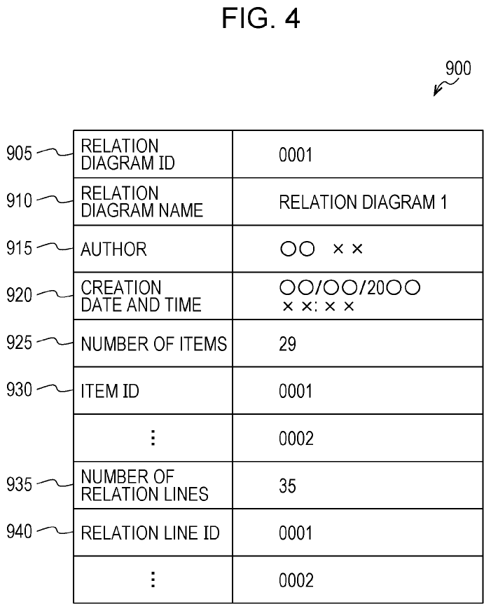

FIG. 4 illustrates a data structure example of a relation diagram information table 900. The relation diagram information table 900 includes a relation diagram identifier (ID) cell 905, a relation diagram name cell 910, an author cell 915, a creation date and time cell 920, a number-of-items cell 925, item ID cells 930, a number-of-relation-lines cell 935, and relation line ID cells 940. In the exemplary embodiment, the relation diagram ID cell 905 stores information (relation diagram ID) for uniquely identifying a relation diagram. The relation diagram name cell 910 stores a name of the relation diagram having the relation diagram ID. The author cell 915 stores an author of the relation diagram. The creation date and time cell 920 stores a date and time at which the relation diagram is created or edited (year, month, day, hour, minute, second, decimal, or a combination thereof). The number-of-items cell 925 stores the number of items in the relation diagram. There are as many item ID cells 930 as the number of items indicated in the number-of-items cell 925 below the number-of-items cell 925. In the exemplary embodiment, the item ID cells 930 store information (item IDs) for uniquely identifying the items. The information indicated by the item IDs is stored in an item information table 1000. The number-of-relation-lines cell 935 stores the number of relation lines in the relation diagram. There are as many relation line ID cells 940 as the number of relation lines indicated in the number-of-relation-lines cell 935 below the number-of-relation-lines cell 935. In the exemplary embodiment, the relation line ID cells 940 store information (relation line IDs) for uniquely identifying the relation lines. The information indicated by the relation line IDs is stored in a relation line information table 1100.

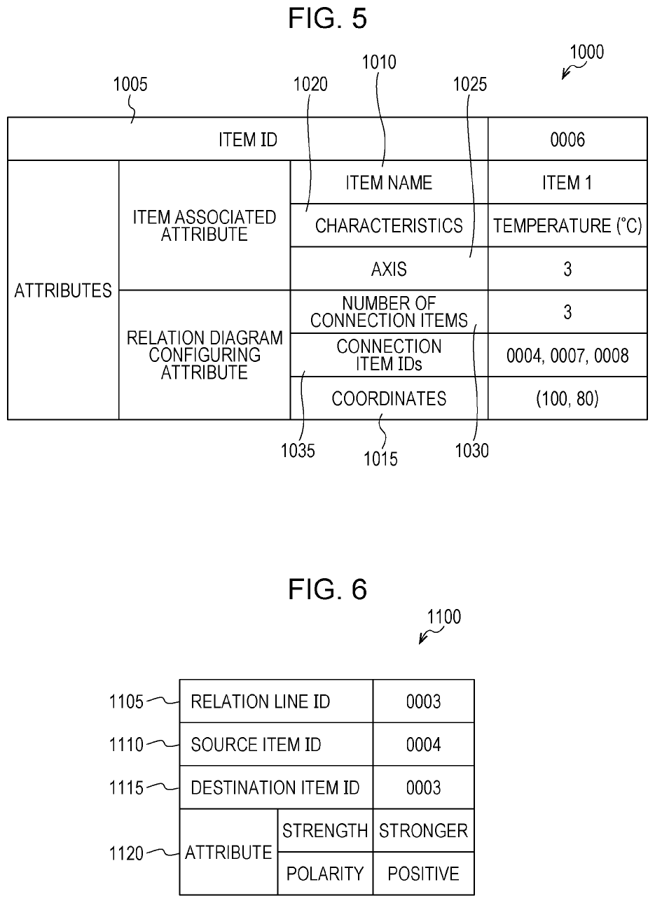

FIG. 5 illustrates a data structure example of the item information table 1000. The item information table 1000 is prepared for each item ID and includes, as attributes, an item associated attribute that is an attribute associated with an item and a relation diagram configuring attribute that is an attribute for configuring a relation diagram. The item associated attribute is attributes such as a name of the item representing an event, characteristics, and an axis to which the item belongs. Note that the characteristics herein include a nature representing an event, a behavior, and an effect. The relation diagram configuring attribute is attributes such as the number of connection items, connection item IDs, and coordinates. Along with the relation diagram configuring attribute, the item information table 1000 includes an item ID cell 1005, an item name cell 1010, a coordinates cell 1015, a characteristics cell 1020, an axis cell 1025, a number-of-connection-items cell 1030, and a connection item ID cell 1035. The item ID cell 1005 stores an item ID. The item name cell 1010 stores a name of an item having the item ID. The coordinates cell 1015 stores coordinates at which the item is displayed in the relation diagram. The characteristics cell 1020 stores characteristics of the item. The axis cell 1025 stores an axis to which an axis item corresponding to the item belongs when the relation diagram is converted into a deployment chart. The number-of-connection-items cell 1030 stores the number of items to which the subject item is connected. That is, the number-of-connection-items cell 1030 stores the total number of items serving as destinations of the item as a source and items serving as sources of the item as a destination. The connection item ID cell 1035 stores as many connection item IDs as the number of items indicated in the number-of-connection-items cell 1030. The connection item ID cell 1035 stores IDs of items serving as destinations and items serving as sources.

FIG. 6 illustrates a data structure example of the relation line information table 1100. The relation line information table 1100 includes a relation line ID cell 1105, a source item ID cell 1110, a destination item ID cell 1115, and an attribute cell 1120. The relation line ID cell 1105 stores a relation line ID of a relation line. The source item ID cell 1110 stores an item ID of an item serving as a source for the relation line. The destination item ID cell 1115 stores an item ID of an item serving as a destination for the relation line. The attribute cell 1120 stores an attribute of the relation line. The attribute is, for example, a polarity of the relation line. The polarity is a nature regarding whether an increase in a numeric value of an item serving as a source increases a numeric value of an item serving as a destination (e.g., in direct proportion) or whether an increase in a numeric value of an item serving as a source decreases a numeric value of an item serving as a destination (e.g., in reverse proportion). Also, the attribute is, for example, the strength of a degree of a relation indicated by the relation line as “stronger”, “strong”, “weak”, or “weaker”, or the direction of a relation indicated by the relation line.

Note that the tables illustrated in FIGS. 4 to 6 are examples, and other data structures may alternatively be used. For example, the data structure of a graph may be used.

In addition, the relation information is not necessarily stored in the storage unit 105. The relation information may be stored in an apparatus other than the server 10.

Next, operations of the server 10 will be described.

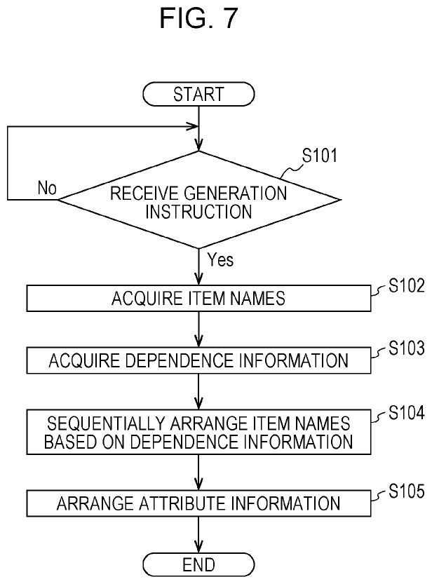

FIG. 7 is a flowchart illustrating a flow of a relation table generation process performed by the server 10. The relation table generation process is performed by the CPU 11 reading a relation table generation program from the ROM 12 or the storage 14 and loading and executing the program in the RAM 13.

First, the CPU 11 waits until receiving a relation table generation instruction from a user terminal 20 (step S101).

The CPU 11 waits for the relation table generation process until receiving the relation table generation instruction from the user terminal 20 (step S101; No).

Upon the relation table generation instruction being received from the user terminal 20 (step S101; Yes), the CPU 11 acquires, from the storage unit 105, item names in the relation information from which a relation table is to be generated (step S102). In a case where a relation table is to be generated from a relation diagram, the CPU 11 acquires, from the relation diagram information table 900, recording of a relation diagram ID of the relation diagram from which a relation table is to be generated, and acquires, from the item information table 1000, recording of item IDs in the acquired recording. Then, the CPU 11 acquires the item names in the acquired recording of the item IDs.

Subsequently to step S102, the CPU 11 acquires relations for the acquired item names (step S103). Specifically, in a case where a relation table is to be generated from a relation diagram, the CPU 11 acquires connection item IDs in the recording of the item IDs acquired from the item information table 1000. In addition, the CPU 11 acquires, from the relation line information table 1100, recording of relation line IDs corresponding to lines connecting the item IDs acquired from the item information table 1000 and the connection item IDs.

Subsequently to step S103, on the basis of the acquired relations, the CPU 11 sequentially arranges the acquired item names to generate a relation table (step S104). In a case where the input relation information includes information about processes, on the basis of the acquired relations, the CPU 11 sequentially arranges the acquired item names in accordance with processes to which the acquired items belong.

Subsequently to step S104, the CPU 11 arranges, next to the respective item names, regions in which attribute information for the arranged item names are to be input to generate a relation table (step S105).

An example of the relation table generated in the relation table generation process performed by the server 10 illustrated in FIG. 7 will be described.

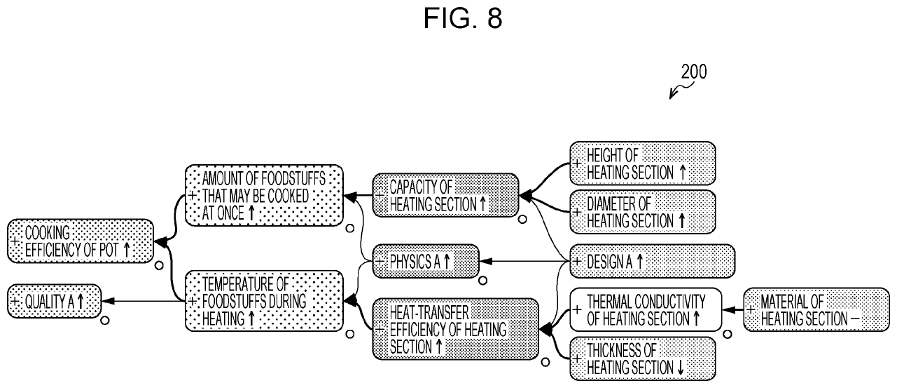

FIG. 8 illustrates an example of a relation diagram from which a relation table is to be generated. The storage unit 105 stores information about a relation diagram 200 illustrated in FIG. 8 in each of the relation diagram information table 900, the item information table 1000, and the relation line information table 1100.

Upon the relation diagram 200 illustrated in FIG. 8 being received, the CPU 11 first acquires information of names of items representing events. From the relation diagram 200 illustrated in FIG. 8, the CPU 11 acquires item names such as “cooking efficiency of pot”, “quality A”, “amount of foodstuffs that may be cooked at once”, “temperature of foodstuffs during heating”, “capacity of heating section”, “heat-transfer efficiency of heating section”, “physics A”, “height of heating section”, “diameter of heating section”, “material of heating section”, “thickness of heating section”, and “design A”.

The relation diagram 200 illustrated in FIG. 8 is composed of four processes, which are “quality”, “function”, “physics”, and “design”. “Quality” is arranged on a first axis, “function” is arranged on a second axis, “physics” is arranged on a third axis, and “design” is arranged on a fourth axis. Information about these axes is stored in the axis cell 1025. “Cooking efficiency of pot” and “quality A” belong to the process “quality”. “Amount of foodstuffs that may be cooked at once” and “temperature of foodstuffs during heating” belong to the process “function”. “Capacity of heating section”, “heat-transfer efficiency of heating section”, and “physics A” belong to the process “physics”. “Height of heating section”, “diameter of heating section”, “material of heating section”, “thickness of heating section”, and “design A” belong to the process “design”.

Note that the item “thermal conductivity of heating section” belongs to none of the plural processes. Thus, the CPU 11 does not acquire “thermal conductivity of heating section”.

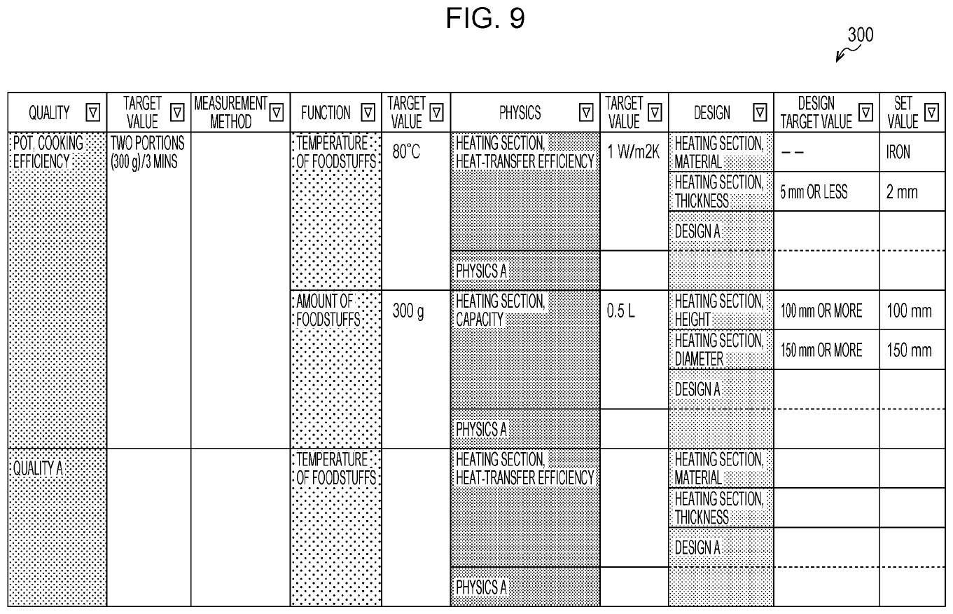

FIG. 9 illustrates an example of a relation table generated from the relation diagram 200 illustrated in FIG. 8. When generating a relation table 300 from the relation diagram 200, the CPU 11 arranges items belonging to each process on the same column.

As illustrated in FIG. 9, the CPU 11 first arranges the processes “quality”, “function”, “physics”, and “design” in a header. Then, the CPU 11 arranges the item names belonging to each process in the order of processes from a higher level.

Since “cooking efficiency of pot” and “quality A” belong to the process “quality”, the CPU 11 arranges “cooking efficiency of pot” and “quality A” in the column of “quality”. Then, next to (on the right of) “cooking efficiency of pot” and “quality A”, the CPU 11 arranges input cells in which attribute information is to be input. In FIG. 9, input cells in which “target value” and “measurement method” are to be input as attribute information are arranged. The CPU 11 may determine the attribute information to be input in input cells by referring to a template created in advance.

Subsequently, since “amount of foodstuffs that may be cooked at once” and “temperature of foodstuffs during heating” belong to the process “function”, the CPU 11 arranges “amount of foodstuffs that may be cooked at once” and “temperature of foodstuffs during heating” in the column of “function”. In this case, referring to relations between the items, “cooking efficiency of pot” is related to “amount of foodstuffs that may be cooked at once” and “temperature of foodstuffs during heating”. Thus, the CPU 11 arranges both “amount of foodstuffs that may be cooked at once” and “temperature of foodstuffs during heating” on the right of “cooking efficiency of pot”. In addition, “quality A” is related to “temperature of foodstuffs during heating”. Thus, the CPU 11 arranges “temperature of foodstuffs during heating” on the right of “quality A”. Then, next to (on the right of) “amount of foodstuffs that may be cooked at once” and “temperature of foodstuffs during heating”, the CPU 11 arranges input cells in which attribute information is to be input. In FIG. 9, input cells in which “target value” is to be input as attribute information are arranged. For arrangement, if there are plural subordinate items having a hierarchical relation with a superordinate item, the CPU 11 splits the row on which the superordinate item is arranged into as many rows as the number of subordinate items, and arranges the subordinate items on the rows to generate a table. For example, since two subordinate items, “amount of foodstuffs that may be cooked at once” and “temperature of foodstuffs during heating”, are related to the superordinate item “cooking efficiency of pot”, the CPU 11 splits the row of the item “cooking efficiency of pot” to arrange the subordinate items “amount of foodstuffs that may be cooked at once” and “temperature of foodstuffs during heating”. In a case where the items arranged in split rows in this manner are adjacent to each other, the CPU 11 may generate a table in which the items are integrated. For example, since identical items “design A” are arranged on the right of the item “heat-transfer efficiency of heating section” and on the right of the item “physics A” and are adjacent to each other in the column direction, the CPU 11 may integrate the items “design A”.

Subsequently, the CPU 11 arranges the item names belonging to the process “physics” and the item names belonging to the process “design” in the same manner. Then, next to (on the right of) the arranged item names, the CPU 11 arranges input cells in which attribute information is to be input.

In a case where attribute information is input in the original relation diagram, the CPU 11 generates the relation table 300 reflecting the input attribute information.

In accordance with an operation from a user terminal 20, the CPU 11 may optionally increase or decrease the number of input cells in which the attribute information corresponding to each item is to be input.

In a relation diagram, symbols indicating polarities may be attached to item names. In the relation diagram 200 illustrated in FIG. 8, an upward arrow means a relation in which an increase in the numeric value of an item serving as a source increases the numeric value of an item serving as a destination. In addition, a downward arrow means a relation in which an increase in the numeric value of an item serving as a source decreases the numeric value of an item serving as a destination. If the relation information from which a relation diagram is to be generated includes information about polarities, the CPU 11 may attach symbols indicating the polarities to item names in a relation table as in the relation diagram.

The relation table generated by the CPU 11 in this manner, in which items belonging to each process are sequentially arranged on the basis of relations, makes it easier to grasp the relations between events than a relation diagram and a deployment chart.

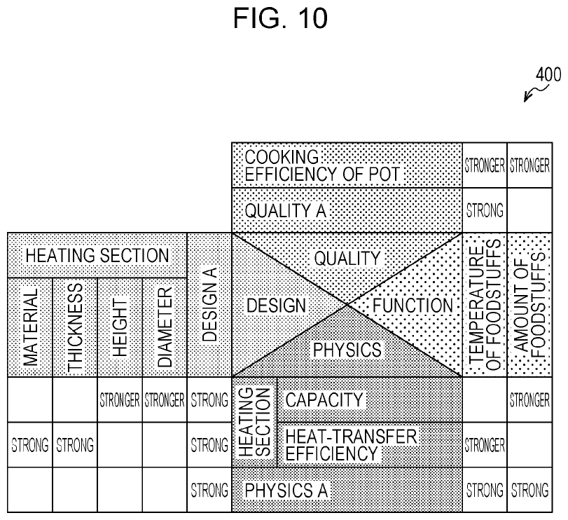

FIG. 10 illustrates a deployment chart created from the relation diagram 200 illustrated in FIG. 8 by using the disclosure disclosed in Japanese Unexamined Patent Application Publication No. 2016-081185. Since four processes are defined in the relation diagram 200, a deployment chart 400 is a four-element chart. In FIG. 10, for items having correspondence relations, circles are provided at corresponding positions (cells) in the deployment chart 400.

In the relation diagram 200 illustrated in FIG. 8, in order to know about items affected by “material of heating section”, it is necessary to track relation lines. In the deployment chart 400 illustrated in FIG. 10, in order to know about items affected by “material of heating section”, it is necessary to know how to interpret a deployment chart and to sequentially track the positions with symbols in the deployment chart.

By contrast, by referring to the relation table 300 illustrated in FIG. 9, for example, it is possible to know that “material of heating section” belonging to the process “design” affects both “cooking efficiency of pot” and “quality A” belonging to the process “quality” without tracking lines or symbols. In addition, by referring to the relation table 300 illustrated in FIG. 9, it is possible to know that the items belonging to the process “design” affecting “temperature of foodstuffs” belonging to the process “function” are “material of heating section”, “thickness of heating section”, and “design A”.

Furthermore, the relation table 300 illustrated in FIG. 9 includes cells in which attribute information is input and displayed, the cells not included in the relation diagram 200 illustrated in FIG. 8 and the deployment chart 400 illustrated in FIG. 10. Thus, the relation table generated by the CPU 11 makes it possible to overlook and grasp not only relations between items but also attribute information of each of the items.

In the relation table generated by the CPU 11, identical items may be displayed on plural rows. For example, referring to FIG. 9, the items “physics A” belonging to the process “physics” are displayed on three rows. Thus, when a user inputs attribute information of a certain item, if identical items are present on other rows, the CPU 11 may display a relation table reflecting the attribute information input by the user in input cells for input of attribute information on the other rows.

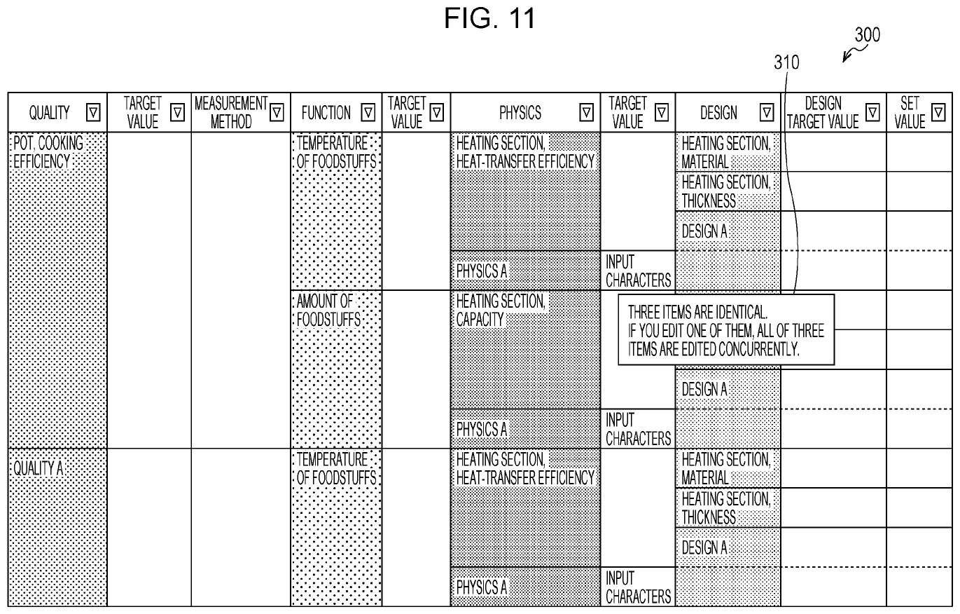

FIG. 11 illustrates an example of the relation table generated by the CPU 11. In FIG. 11, in the relation table 300, a character string is being input as attribute information of the item “physics A” belonging to the process “physics”. In this case, the CPU 11 displays the relation table reflecting the character string such that the same character string is input as attribute information of all the items “physics A”.

In a case where a user selects an item or attribute information thereof in a relation table, if the item is present on other rows, the CPU 11 may notify the user that the same attribute information is present on the other rows in the relation table. In addition, in a case where a user selects an item or attribute information thereof in a relation table, if the item is present on other rows, the CPU 11 may notify the user of the number of pieces of the same attribute information in the relation table.

In the example illustrated in FIG. 11, a pop-up window 310 is displayed on the relation table 300. The pop-up window 310 displays a notification that, if a user selects an input cell for attribute information of the item “physics A” belonging the process “physics”, three identical items are present and attribute information of the identical items are edited concurrently.

The server 10 according to the exemplary embodiment is capable of generating a relation table by which it is possible to easily overlook relations between events including attribute information that is set for each item. In addition, the server 10 according to the exemplary embodiment makes it possible to easily organize downstream events in a relation diagram by generating a relation table provided with input cells in which attribute information of identical items may be edited. Furthermore, the server 10 according to the exemplary embodiment notifies a user of the presence of plural input cells in which attribute information of identical items may be concurrently edited, thereby preventing unintended change of attribute information.

Although the exemplary embodiment describes a case where the relation table generation program is stored (installed) in the ROM or the storage in advance. However, the disclosure is not limited to this. The program may be provided by being stored in a storage medium such as a Compact Disk Read Only Memory (CD-ROM), a Digital Versatile Disk Read Only Memory (DVD-ROM), or a Universal Serial Bus (USB) memory. Alternatively, the program may be downloaded via a network from an external apparatus.

In the embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
receive relation information generated by systematically connecting a plurality of items representing events in accordance with relations of the items,
extract, from the relation information, information for identifying the items and information for identifying the relation for each of the items,
arrange the items based on the extracted information for identifying the relation for each of the items to generate a table in which attribute information of the items is allowed to be input, and
output the generated table.

2. An information processing apparatus comprising:
a processor configured to
receive relation information generated by systematically connecting a plurality of items representing events in accordance with relations of the items,
arrange, based on the relation information, an item among the items on a row on which attribute information corresponding to the item is allowed to be input and arrange a plurality of subordinate items connected to the item on rows obtained by splitting the row to generate a table, and
output the generated table.

3. The information processing apparatus according to claim 1,
wherein identical items among the items are displayed on a plurality of rows, and
wherein, when editing attribute information corresponding to an item among the identical items, the processor concurrently edits attribute information of other identical items.

4. The information processing apparatus according to claim 2,
wherein identical items among the items are displayed on a plurality of rows, and
wherein, when editing attribute information corresponding to an item among the identical items, the processor concurrently edits attribute information of other identical items.

5. The information processing apparatus according to claim 3,
wherein, when editing the attribute information corresponding to the item, the processor displays the table such that all of the identical items are present.

6. The information processing apparatus according to claim 4,
wherein, when editing the attribute information corresponding to the item, the processor displays the table such that all of the identical items are present.

7. The information processing apparatus according to claim 1,
wherein, when editing attribute information corresponding to an item among the items in the table, if other items identical to the item are present in the table, the processor displays a notification that the other items are present.

8. The information processing apparatus according to claim 2,
wherein, when editing attribute information corresponding to an item among the items in the table, if other items identical to the item are present in the table, the processor displays a notification that the other items are present.

9. The information processing apparatus according to claim 7,
wherein the processor displays a notification of information about the number of the other items.

10. The information processing apparatus according to claim 8,
wherein the processor displays a notification of information about the number of the other items.

11. The information processing apparatus according to claim 1,
wherein the processor generates the table in which the items are arranged in a column direction in an order of the relations from a higher level.

12. The information processing apparatus according to claim 2,
wherein the processor generates the table in which the items are arranged in a column direction in an order of the relations from a higher level.

13. The information processing apparatus according to claim 11,
wherein the processor generates the table in which at least one cell for receiving input of the attribute information is arranged next to an item.

14. The information processing apparatus according to claim 12,
wherein the processor generates the table in which at least one cell for receiving input of the attribute information is arranged next to an item.

15. The information processing apparatus according to claim 1,
wherein the processor reflects an editing result of the attribute information in the relation information, from which the table is to be generated.

16. The information processing apparatus according to claim 2,
wherein the processor reflects an editing result of the attribute information in the relation information, from which the table is to be generated.

17. The information processing apparatus according to claim 1,
wherein the relation information is a relation diagram representing the relations by linking the items via lines.

18. The information processing apparatus according to claim 2,
wherein the relation information is a relation diagram representing the relations by linking the items via lines.

19. The information processing apparatus according to claim 1,
wherein each of the items belongs to any of a plurality of processes, and
wherein the relation information is a deployment chart representing the relations in which the items are deployed on axes of the processes.

20. A non-transitory computer readable medium storing a program causing a computer to execute a process for information processing, the process comprising:
receiving relation information generated by systematically connecting a plurality of items representing events in accordance with relations of the items;
extracting, from the relation information, information for identifying the items and information for identifying the relation for each of the items;
arranging the items based on the extracted information for identifying the relation for each of the items to generate a table in which attribute information of the items is allowed to be input; and
outputting the generated table.
